(19) United States
(12) Patent Application Publication
(10) Pub. No.: US 2007/0170396 A1
(43) Pub. Date: Jul. 26, 2007

(54) Photostimulable glass ceramic

(76) Inventors: Graham Appleby, Wellington (NZ); Grant Williams, Wellington (NZ); Andrew Edgar, Wellington (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/339,970

(22) Filed: Jan. 26, 2006

(51) Int. Cl. C09K 11/08; C09K 11/61

(52) U.S. Cl. 252/301.4 F; 252/301.4 R; 501/32; 252/301.6 F; 252/301.6 R; 252/301.4 H; 501/10; 501/3; 501/5

(57) ABSTRACT

A glass-ceramic material containing phosphor-doped crystallites suitable for thermal neutron detection is disclosed, the glass-ceramic material being capable of storing at least part of the energy of incident thermal neutrons, and releasing at least part of the energy by optical stimulation. A method for preparation of the glass-ceramic material is also disclosed.

### FIELD OF THE INVENTION

The invention relates to thermal neutron detection materials. More particularly but not exclusively it relates to a glass ceramic material consisting of a glass matrix containing microcrystallites capable of imaging objects in a beam of thermal neutrons.

### BACKGROUND OF THE INVENTION

Thermal neutron imaging plates, as disclosed in Fuji's U.S. Pat. No. 5,635,727 for example, are a means for imaging internal structure, and provide a complimentary image to standard x-ray imaging. While x-rays are attenuated by elements with high atomic number, for thermal neutrons the reverse is generally true, resulting in radiographs that show the distribution of light elements, such as hydrogen, within an object. Commercially available neutron imaging plates (NIPs) from Fujifilm (e.g. Fuji NIP BAS-ND) contain a powder mix of Gd₂O₃ and BaFBr (doped with 1000 ppm Eu²⁺) in a polymer binder on a supporting layer. They can contain either naturally occurring ¹⁵⁵Gd and ¹⁵⁷Gd, or contain an enrichment of the ¹⁵⁷Gd isotope that has a high cross section for thermal neutron capture. Exposure to thermal neutron radiation gives rise to a nuclear reaction in ¹⁵⁵Gd and ¹⁵⁷Gd that results in radio-isotopes, γ-rays and conversion electrons (also known as β radiation). The conversion electrons are detected in the BaFBr (doped with 1000 ppm Eu²⁺) crystallites via the creation of electron-hole pairs; some of these electrons and holes are trapped at sites which are stable post-irradiation. The concentration of trapped electrons and holes is related to the neutron dose and the spatial distribution represents the 2D image of any object placed in path of the neutron beam.

The dose information is read out via stimulation with red light that leads to electron-hole recombination, and consequent excitation of the luminescent ion (Eu²⁺). The decay from the excited state results in the emission of light, which is detected with a photomultiplier. This stimulation process is called optically-stimulated luminescence (OSL). If the stimulation is generated by a raster-scanned red laser beam, then the OSL intensity follows that of the thermal neutron image. The read-out process is destructive in nature, but the imaging plate can then be re-used.

However, the use of the high Z elements, Gd, Ba and Br in Fuji's NIP results in a high sensitivity to the broad γ-radiation background present in neutron experiments. This diminishes the resulting image quality. A further problem is the scattering of the stimulating read-out light by powder grains which are an essential part of the NIP structure, resulting in poor spatial resolution.

The use of a storage phosphor made purely of glass can overcome the scattering problem, and it was disclosed in U.S. Pat. No. 5,977,556 and EP 0779,254 A1 that fluoroaluminate and also other oxide-based glasses containing europium or cerium ions show a photo-stimulable x-ray storage phosphor effect, but the relative magnitude of the effect was not stated and in fact the effect is too small for practical applications. This pure glass structure is also not suitable for thermal neutron detection because there are no nuclei for thermal neutron capture.

### OBJECT OF THE INVENTION

It is the object of this invention to provide a photo-stimulable glass-ceramic containing micro-crystals suitable for the detection and/or imaging of thermal neutrons, and/or to overcome one or more of the abovementioned disadvantages, and/or to at least provide the public with a useful alternative.

### SUMMARY OF THE INVENTION

In the first aspect, the present invention provides a glass-ceramic material containing phosphor-doped crystallites, the glass-ceramic material capable of storing at least part of the energy of incident thermal neutrons, and releasing at least part of the energy by optical stimulation.

Preferably the glass-ceramic comprises the crystallites dispersed throughout a glass matrix.

Preferably the crystallites are microcrystallites with particle size in the range 10-1000 nm.

Preferably the glass matrix has a composition:
(1-x-y)B₂O₃-xMₚO_{q}-yNᵣOₛ
wherein M, N are each selected from the group consisting of Li, Na, K, Rb, Cs, Ag, Mg, Ca, Sr, Zn, Pb, Al, La, Ba, Fe, Ti, Si, Mn and Gd), and p, q, r, s are 1, 2, or 3 as appropriate for each oxide.

Preferably the phosphor-doped crystallites are selected from one or more of the group consisting of:
MX:Z^{d+} (where M is one of Li, Na, K, Rb, Cs;
and X is one of F, Cl, Br, I), and
MX₂:Z^{d+} (where M is one of Mg, Ca, Cd, Zn, Sr, Ba,
and X is one of F, Cl, Br, I), and
MXY:Zd^{d+} (where M is one of Mg, Ca, Cd, Zn, Sr, Ba,
and X is one of F, Cl, Br, I;
and Y is one of F, Cl, Br, I), and
MₐN_{b}X_{c}:Z^{d+} (where M is one of Li, Na, K, Rb, Cs;
and N is one of Mg, Ca, Sr, Ba, Cd, Zn;
and X is one of F, Cl, Br, I;)
   with values abc corresponding to 113, 214 or 125.
   wherein Z^{d+} is the dopant phosphor ion and is selected from the group consisting of the transition metal ions Cu⁺, Ag⁺, Mn²⁺, Mn⁴⁺, Cr³⁺ or rare earth metal ions: Eu²⁺, Sm²⁺, Sm³⁺, Ce³⁺, Pr³⁺, Gd³⁺, Tb³⁺, or Tl⁺, In⁺, Ga⁺, and Pb²+.

Preferably the glass matrix may also contain up to 6 mol % SiO₂.

Preferably the glass matrix may be enriched with the ¹⁰B and/or ⁶Li isotopes. Alternatively the glass matrix or the crystallites can contain Gd which is enriched with the ¹⁵⁷Gd isotope.

Preferably the glass-ceramic is also sensitive to one or more other forms of radiation selected from the group consisting of x-rays, gamma-rays, beta radiation, alpha radiation and other forms of ionizing radiation.

In a second aspect the present invention provides a method for producing a glass-ceramic material containing phosphor-doped crystallites, the glass-ceramic material capable of storing at least part of the energy of incident thermal neutrons, and releasing at least part of the energy by optical stimulation, the method comprising the steps:
[1] mixing the glass-ceramic precursors,
[2] thermal treatment at or above a melting temperature to melt the glass-ceramic precursors,
[3] quenching to below the melting temperature,
[4] production of a glass-ceramic containing or hosting phosphor-doped crystallites.

Preferably one of the glass-ceramic precursors is a boron oxide or a source of boron oxide. More preferably one of the glass-ceramic precursors is B₂O₃ or orthoboric acid H₃BO₃. More preferably the B₂O₃ or H₃BO₃ is ¹⁰B-enriched.

Preferably one or more or all the steps [1] to [4] is/are carried out in an inert atmosphere, preferably of argon. Alternatively one or more or all of the steps [1] to [4] are carried out under a mixture of argon and up to 5% by volume hydrogen.

In one embodiment steps [3] to [4] may involve:
quenching to a temperature between 25° C. to 300° C.,
slow cooling to room temperature,
annealing to between 450° C. and 550° C., and
cooling to room temperature to produce the glass-ceramic.

In an alternative embodiment steps [3] to [4] may involve:
quenching to a temperature between 450° C. to 550° C., and
slow cooling to room temperature
   to produce the glass-ceramic.

Preferably step [2] comprises the step of heating the glass-ceramic precursors, preferably in an inert atmosphere and at a temperature to melt the glass-ceramic precursors to a molten mixture. Preferably the heating is to a temperature between 800° C. and 1200° C. Most preferably to a temperature of 1000° C.

Preferably, the glass-ceramic precursors comprise boron oxide (B₂O₃), one or more metal oxides (where the metal is selected from the group consisting of Li, Na, K, Rb, Cs, Ag, Mg, Ca, Sr, Cd, Zn, Pb, Al, La, Ba, Fe, Ti, Si, Mn, and Gd, a metal (A) halide (where A is selected from the group consisting of Li, Na, K, Rb, Mg, Ca, Sr, Ba, Cs, Cd, Zn) and optionally a metal (B) halide (where B is selected from the group consisting of Li, Na, K, Rb, Mg, Ca, Sr, Ba, Cs, Cd, Zn), and up to 2 mole percent dopant phosphor halides or oxides (where the dopant phosphor is selected from the group consisting of: Eu, Sm, Ce, Tb, Ti, In, Ga, Pr, Cu, Ag, Mn, Cr and Pb).

Preferably the glass-ceramic precursors form a mixture in which the boron content is greater than 55 mol %.

Preferably SiO₂ and TiO₂ are added.

Preferably prior to step [1] there are the pre-steps of heating B₂O₃ to a temperature greater than 450° C., preferably 500° C., for a period of time (for example 60 minutes) and then adding the remaining precursors to the mix and heating to a temperature greater than 500° C., preferably 550° C., and held there for a period of time (for example 30 minutes).

In a third aspect the present invention provides a glass-ceramic material containing phosphor-doped crystallites, the glass-ceramic material capable of storing at least part of the energy of incident thermal neutrons, and releasing at least part of the energy by optical stimulation, prepared substantially according the abovementioned method.

In a fourth aspect the present invention provides a method for recording and reproducing a thermal neutron image comprising the steps of:
i) providing a glass-ceramic material as described above,
ii) causing thermal neutron radiation to be incident upon the glass-ceramic material (through an object to be imaged), so that the glass-ceramic material stores energy from the radiation;
iii) exposing the glass-ceramic to stimulating radiation to release the stored energy as emitted light;
iv) detecting the emitted light for imaging.

Preferably the stimulating radiation is light of wavelength between 350-1000 nm.

Other aspects of the invention may become apparent from the following description which is given by way of example only and with reference to the accompanying drawings.

As used herein the term “glass-ceramic” means an amorphous glass that has been thermally treated to form a nanocrystalline or microcrystalline phase within the glass matrix. The crystallites are typically 10-1000 nm in size.

As used herein the term “storing” with respect to energy or radiation means that following irradiation part of the energy is stored in the form of trapped electrons and holes. Subsequent exposure to stimulating light leads to detrapping of the trapped electrons and holes followed by energy transfer to the luminescent ion and then the emission of light from the luminescent ion.

As used herein the term “phosphor-doped” with respect to the crystallites, means that up to a few percent of the ions in the crystallites have been replaced with a different ion, which results in new properties. For example, in the glass-ceramics described in the examples, 0.5 mol % Eu²⁺-doped BaCl₂ (or BaCl₂:Eu²⁺) means that 0.5 % of the Ba²⁺ ions are replaced with Eu²⁺ ions. This results in the crystal's ability to emit blue light following appropriate stimulation (of V, x-rays, γ-rays, neutrons etc) which would not be possible without the Eu²⁺ dopant.

As used herein the term “quenching” to a particular temperature means the rapid cooling of the melted glass to a lower temperature where a solid glass or glass-ceramic is obtained. For example, the melted glass can be poured onto a colder metal surface or mold at the said temperature to form a solid glass or glass-ceramic. It will be appreciated by practitioners in the art that the quenching may also proceed by contact with liquids or gases which are cooler than the glass melt.

As used herein the term “thermal neutrons” means neutrons of energy 10-300 meV

As used herein the term “and/or” means “and” or “or”, or both.

As used herein “(s)” following a noun means the plural and/or singular forms of the noun.

The term “comprising” as used in this specification means “consisting at least in part of”, that is to say when interpreting independent paragraphs including that term, the features prefaced by that term in each paragraph will need to be present but other features can also be present.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The invention will now be described by way of example only and with reference to the drawings in which:

FIG. 1 illustrates a high level flow diagram for the method of the invention.

FIG. 2 shows the XRD patterns recorded using a Cu tube for (a) unannealed 57.8B₂O₃-25.4Li₂O-4.9LiF-11.4BaCl₂:0.5% Eu²⁺ glass and (b) the same glass annealed at 520° C. for 220 minutes. The compositions are quoted in mole %. The asterisk denotes a line of a minor phase that is suspected to be due to crystallisation of the lithium borate. The standard XRD pattern (ICDD # 24-0094) for orthorhombic BaCl₂ is also shown.

FIG. 3 shows the XRD patterns recorded using a Cu tube for (a) unannealed 55.3B₂O₃-25.2Li₂O-4.9LiF-14.1BaCl₂:0.5% Eu²⁺ glass-ceramic; and (b) the same glass-ceramic annealed at 540° C. for 10 minutes. The standard XRD pattern (ICDD # 24-0094) for orthorhombic BaCl₂ is also shown.

FIG. 4 shows the total Thermally Stimulated Luminescence (TSL) from 55.3B₂O₃-25.2Li₂O-4.9LiF-14.1BaCl₂:0.5% Eu²⁺ (Eu²+=0.5 mol %) glass-ceramic annealed at 540° C. for 10 minutes as a function of dose of β-irradiation. The compositions are quoted in mole %. The heating rate used was 1K/s.

FIG. 5 shows the OSL conversion efficiency (CE) of 55.3B₂O₃-25.2Li₂O-4.9LiF-14.1BaCl₂:0.5% Eu²⁺ glass-ceramics annealed at 540° C. for 10 minutes, as a function of Eu²⁺ content. The compositions are quoted in mole %. The OSL was stimulated using x-rays from a W anode, while the conversion efficiency was computed with respect to the commercial Fuji NIP BAS-ND. The line is a guide to the eye.

FIG. 6(a) shows a photograph of a standard ASTM Neutron Image Sensitivity Indicator (scale in cm). (b) shows part of the neutron image of the ASTM Neutron Image Sensitivity Indicator recorded on the Fuji BAS-ND imaging plate and (c) the neutron image the ASTM Neutron Image Sensitivity Indicator recorded on a 55.3B₂O₃-25.2Li₂O-4.9LiF-14.1BaCl₂:0.5% Eu²⁺ glass-ceramic annealed at 540° C. for 10 minutes. The compositions are quoted in mole %. Image read out was made using a Fuji BAS2500 scanner.

### DETAILED DESCRIPTION OF THE INVENTION

The present invention relates to neutron imaging plates, dosimeters, or other radiation-monitoring devices based on glass-ceramics containing radiation sensitive crystallites embedded in a glass matrix. The neutrons are absorbed in the glass matrix and some of the emission products are detected in the radiation sensitive crystallites via the excitation and trapping of electrons and holes. The concentration of trapped electrons and holes is related to the neutron dose and their distribution represents a latent image for neutron imaging applications. The stored dose or image information can be read out promptly or at a later time by optically-stimulated luminescence (OSL).

The invention has been developed primarily for thermal neutron imaging plates, with read-out via OSL, and will be described hereinafter with reference to this application. However, it is to be appreciated that the invention is not limited to this particular field of use, and may be used for other radiation monitoring devices that include dosimeters and scintillators, and which may be based on glass fibres rather than plates. It is also to be appreciated that the thermal neutron image or dose information can be read-out via thermo-stimulated luminescence (TSL).

The preferred neutron imager of the invention is a boron oxide-metal oxide glass matrix containing metal phosphor ion doped—metal halide crystallites. The overall phase is a glass-ceramic phase.

The Glass System

The glass system is based on a boron oxide-metal oxide system. There are a number of specific compositions for the glass, depending on the identity of the metal(s) M and/or N. These are:
(1-x-y)B₂O₃-xMₚO_{q}-yNᵣOₛ
(where M, N are one of Li, Na, K, Rb, Cs, Ag, Mg, Ca, Sr, Zn, Pb, Al, La, Ba, Fe, Ti, Si, Mn, Gd), and p, q, r, s are 1, 2, or 3 as appropriate for each oxide.

The boron oxide component of the system is conveniently based on B₂O₃. However, other forms or sources of boron oxide may be used, including orthoboric acid H₃BO₃, as would be appreciated by one skilled in the art.

Preferably the main glass-ceramic precursor is boron oxide, B₂O₃ but other precursors such as orthoboric acid and different B₂O₃.xH₂O compounds are possible, as well as such species as Li₂B40₇ as would be appreciated by one skilled in the art. The use of either B₂O₃ or H₃BO₃ is the most useful due to the availability of ¹⁰B-enriched B₂O₃ and H₃BO₃.

In the preferred embodiment up to 6 mol % SiO₂ is added to improve stability against hydration.

In a preferred embodiment, the boron and/or lithium content of this glass system can also be enriched with up to 100% ¹⁰B and/or ⁶Li. Alternatively the glass matrix can contain Gd or be enriched with up to 100% ¹⁵⁵Gd or ¹⁵⁷Gd. Naturally occurring B, Li and Gd contain only a partial percentage of the strongly neutron absorbing isotopes ¹⁰B, ⁶Li, ¹⁵⁵Gd or ¹⁵⁷Gd isotopes. For example, natural B contains 19.9% ¹⁰B and 80.1% ¹¹B. ¹⁰B is useful for absorbing neutrons, but ¹¹B will not absorb many. Thus, it is preferable if a substantial proportion, if not all, of the B atoms are ¹⁰B to ensure that most neutrons are absorbed. However, this is simply a preferred characteristic of the glass of the invention. The same is true for Li and Gd. It is possible to buy ‘enriched’ ¹⁰B₂O₃ or ¹⁰B metal in which 99% of B atoms are ¹⁰B which leads to more efficient imaging plates. For Li, ⁶Li metal, and ⁶Li₂CO₃ are available.

The Crystallites

The crystallites are generally distributed homogeneously throughout the glass matrix. The identity of the phosphor-doped crystallites used is as follows:
MX:Z^{d+} (where M is one of Li, Na, K, Rb, Cs;
and X is one of F, Cl, Br, I), and
MX₂:Z^{d+} (where M is one of Mg, Ca, Cd, Zn, Sr, Ba;
and X is one of F, Cl, Br, I), and
MXY:Z^{d+} (where M is one of Mg, Ca, Cd, Zn, Sr, Ba;
and X is one of F, Cl, Br, I;
and Y is one of F, Cl, Br, I), and
MₐN_{b}X_{c}:Z^{d+} (where M is one of Li, Na, K, Rb, Cs;
and N is one of Mg, Ca, Sr, Ba, Cd, Zn;
and X is one of F, Cl, Br, I;)
with values abc corresponding to 113, 214 or 125.
   and where Z^{d+} is the dopant phosphor ion and is selected from the group consisting of the transition metal ions Cu⁺, Ag⁺, Mn²⁺,Mn⁴⁺, Cr³⁺ or rare earth metal ions: Eu²⁺, Sm²⁺, Sm³⁺, Ce³⁺, Pr³⁺, Gd³⁺, Tb³⁺, or Tl⁺, In⁺, Ga⁺, and Pb²⁺.

In the preferred embodiment of the invention only one type of crystallite species is used in a particular glass ceramic of the invention. However, in alternative embodiments two or more crystallite species could be used, and resultant glass-ceramics are within the scope of the invention.

It should be noted that any crystallite doped with phosphor ions can be used provided they are sensitive to the radiation by-products from the nuclear capture of the neutron in the glass matrix or in the crystallites (e.g. sensitive to α or β particles). In a preferred embodiment the doping is obtained by adding between 0.01-2, or more likely 0.01-1 mol % of a phosphor ion compound to the powder mix melted to form the glass. In one example, 12 mol % of BaCl₂ and 0.02 mol % EuCl₂ are added to the powder mix, resulting in Eu²⁺ doped BaCl₂ crystallites (abbreviated as BaCl₂:Eu²⁺).

In a second example, 6% of BaCl₂ and 6% of BaF₂ and 0.02% of EuCl₂ are added to the powder mix and result in Eu²⁺ doped BaFCl crystallites (here abbreviated BaFCl: Eu²⁺). The europium may also be added as the chloride, fluoride or the oxide after the basic glass has been prepared in a second melting process. Also Eu²⁺ could also be added after the glass has melted. Nucleating agents (for example TiO₂) can be added to the precursors or the glass melt to promote uniform crystallite growth.

In one embodiment the crystallites can contain Gd or be enriched with ¹⁵⁷Gd.

The crystallite size can range from 10 nm-1000 nm.

Penetrating Radiation

The principal radiation able to be imaged is thermal neutron radiation (10-300 meV). However, the material is also sensitive to x-rays, gamma-rays, beta radiation, alpha radiation and other forms of ionizing radiation.

The means by which the thermal neutron radiation is imaged is as follows. The neutrons are captured in the glass matrix via ¹⁰B(n,α)⁷Li and/or ⁶Li(n,α)³H reactions (when Li is used for example). The ¹⁰B reaction also result in γ-radiation.

The reactions in full are:
⁶Li+¹n→³H(2.74 MeV)+⁴He(2.05 MeV)
¹⁰B+¹n→⁷Li(1.0 MeV)+⁴He(1.8 MeV) (7%)
¹⁰B+¹n→⁷Li(0.84 MeV)+⁴He(1.47 MeV)+γ(0.48 MeV) (93%)

The resultant α particles pass through the crystallites and leads to electron excitation and the trapping of electrons and holes within the crystallites.

Alternatively the glass matrix or crystallites can contain ¹⁵⁷Gd and/or ¹⁵⁵Gd. The interaction with neutrons leads to conversion electrons and γ-radiation. The conversion electrons pass through the crystallites leading to trapped electrons and holes. The concentration and distribution of trapped electrons and holes can be determined by OSL.

The reactions in full are:
¹⁵⁵Gd+¹n→¹⁵⁶Gd+γ(7.9 MeV)+c.e's (0.04-0.25 MeV)
¹⁵⁷Gd+¹n→¹⁵⁸Gd+γ(8.5 MeV)+c.e's (0.03-0.23 MeV)

Nucleating agents (for example TiO₂) can be added to the precursors or the glass melt to promote uniform crystallite growth.

The Preferred Method of Preparation of the System

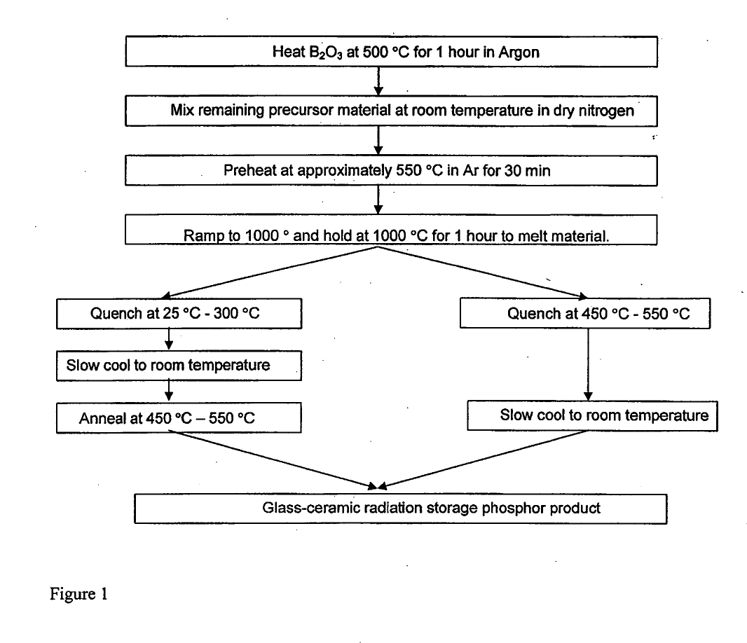

The preferred method of preparation is illustrated in FIG. 1. B₂O₃ is added to the crucible and heated to 500° C. to remove any water. It can be heated in a temperature range from 450° C. to 550° C. The gas is preferably argon to ensure that there is no decomposition of B₂O₃. For example, heating in dry nitrogen could lead to some decomposition of the B₂O₃.

The crucible is removed from the hot zone and the remaining precursors are added.

The mixture is heated to 500° C. in Ar for a period of time (for example 30 minutes) to remove any water. The temperature can range from 450° C. to 550° C. It can also be heated in a Argon-hydrogen (up to 5%) mix and with the hydrogen volume fraction being less the flash point value for safely reasons. This will ensure that the phosphor ions will be in the correct valences (e.g. Eu²⁺) through chemical reduction. For example, Eu₂O₃ (Eu³⁺) can be added to the starting mix. Heating in 95% argon-5% hydrogen will lead to the required valence (Eu²⁺) in the final product.

The temperature is ramped to 1000° C. and held there for a period of time (for example 1 hour) to melt the material. This temperature can range from 800° C. to 1200° C.

The mix is then rapidly removed from the hot zone and quenched on to a surface that is held at a temperature of up to 550° C. to produce a glass or a glass-ceramic.

Production of the glass is indicated on the left side of the flow diagram. In this case the molten mix must be quenched at a temperature low enough so that there is no crystallization (below 300° C.). Typically it is quenched to the glass temperature and then slow cooled to room temperature to ensure that there is no residual stress in the glass. The glass is then heated to a higher temperature of up to 550° C. to produce the glass-ceramic. This temperature can range from 450° C. to 550° C.

Direct production of the glass-ceramic is shown on right side of the flow diagram. In this case the melt is quenched at a temperature ranging from 450° C. to 550° C. It is then slow cooled to room temperature to reduce stresses in the glass-ceramic product.

These steps lead to the glass-ceramic thermal neutron detector or imaging plate product.

### Experimental

A specific embodiment of this invention is a glass-ceramic produced from 52.6 mole % of B₂O₃, 24.3 mole % of Li₂O, 4.7 mole % of LiF, 14.2 mole % of BaCl₂, 0.4 mole % of EuCl₂ and 3.8 mol % SiO₂ to minimise the problem of hygroscopy in 2B₂O₃—Li₂O glass. The B₂O₃ was dried at 500° C. for one hour in a Pt crucible in an Ar atmosphere to remove moisture. The remaining chemicals were added in a nitrogen atmosphere and then melted in a platinum crucible at 1000° C. in a dry inert atmosphere of argon. The melt was then splat-quenched onto a hotplate held at 300° C. and allowed to cool to room temperature at 20° C./hr.

The glass was annealed at temperatures between 520° C. and 540° C. which results in the formation of BaCl₂:Eu²⁺ nano-crystallites within the glass matrix. The nano-crystallites are in excess of 80 nm in size. The resulting annealed glass-ceramic enriched with 99% ¹⁰B₂O₃ has an optically stimulated luminescence conversion efficiency to thermal neutrons that is 60% of the value measured in commercial Fuji NIP BAS-ND. When using natural B₂O₃ the conversion efficiency was 15%.

The thermal neutron phosphor efficiency was measured at room temperature relative to a Fuji NIP BAS-ND. Neutron irradiation with 48 meV neutrons was performed using one of the beamlines of the IRI nuclear research reactor in Delift, the Netherlands. 1 mm thick samples containing 0.5 mol % Eu²⁺ were exposed for 30 seconds to the neutron flux, measured to be around 1×10⁵ cm⁻² s⁻¹. OSL was detected using a Risø-TL/PSL-DA-15A/B reader. The conversion efficiency was determined by stimulating the sample at 550 nm and recording the optically stimulated luminescence using a photomultiplier tube appropriately filtered to only receive blue light. The time dependence of the optically stimulated luminescence was measured and time-integrated to determine the conversion efficiency.

The x-ray storage phosphor efficiency was measured at room temperature relative to the BAS-ND using x-rays from an A1 filtered W tube operated at 50 keV, 20 mA. The efficiency was found to be around 10% of that of the BAS-ND.

The glass-ceramic of the present invention can be used to produce a radiation imaging device by combining such glass-ceramic materials with a radiation source, preferably thermal neutrons, to irradiate the glass-ceramic. Subsequent irradiation with stimulating electromagnetic radiation can be used to cause luminescence in the glass-ceramic or crystalline materials to create an image.

Specific examples of annealing and efficiency are contained in the examples below.

### EXAMPLE 1

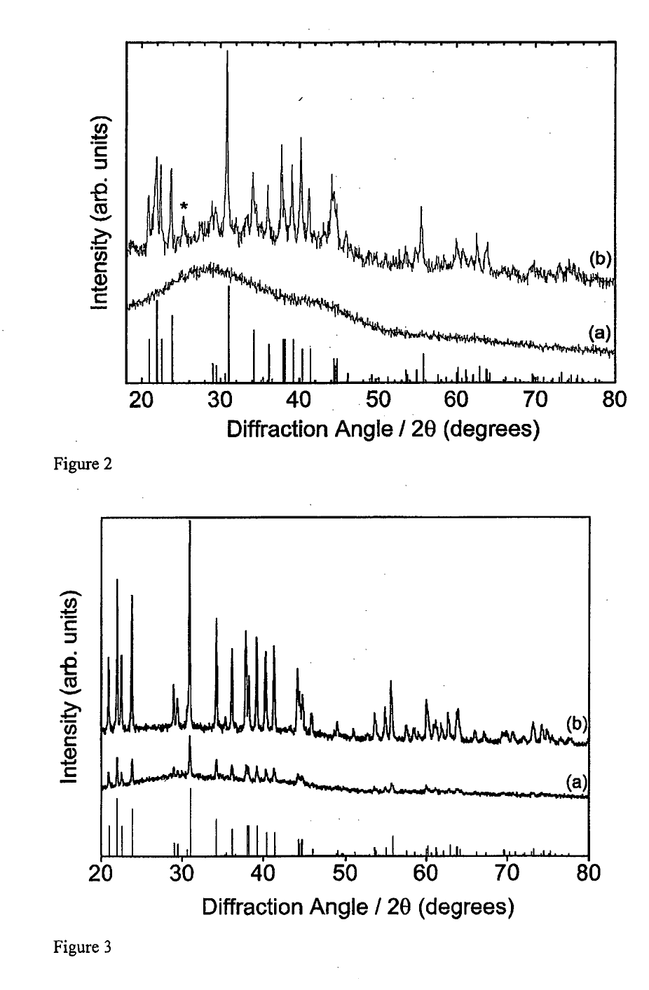

A borate glass made from 54.5 mole % of B₂)₃, 24.9 mole % of Li₂O, 5.0 mole % of LiF, 11.2 mole % of BaCl₂, 0.5 mole % of EuCl₂ and 3.9 mol % SiO₂. It was quenched to 300° C. The as-made glass was amorphous as can be seen in FIG. 2(a). The glass was annealed at 520° C. for 220 minutes to produce a glassramic containing BaCl₂:Eu²⁺ crystallites and the XRD pattern is shown in FIG. 2(b). The asterisk denotes a line of a minor phase that is due to crystallisation of the lithium borate. The standard XRD pattern (ICDD #24-0094) for orthorhombic BaCl₂ is also shown. The as-made glass was not sensitive to x-rays and hence it is not expected to be sensitive to thermal neutrons. The glass-ceramic was sensitive to x-rays and had an x-ray OSL conversion efficiency of 1% relative to the BAS-ND.

### EXAMPLE 2

A borate glass made from 52.6 mole % of B₂O₃, 24.3 mole % of Li₂O, 4.7 mole % of LiF, 14.2 mole % of BaCl₂, 0.4 mole % of EuCl₂ and 3.8 mol % SiO₂. It was quenched to 300° C. The as-made glass contained some small crystallites of BaCl₂:Eu²⁺ as can be seen in FIG. 3(a). The glass-ceramic was annealed at 540° C. for 10 minutes that resulted in larger BaCl₂:Eu²⁺ crystallites with an increased volume fraction as can be seen in FIG. 3(b). The annealed glass-ceramic was sensitive to x-rays and had an x-ray OSL conversion efficiency of 5% relative to the BAS-ND. The OSL conversion efficiency to thermal neutrons enriched with 99% ¹⁰B₂O₃ is 60% of the value measured in commercial Fuji NIP BAS-ND. A similar sample made without boron enrichment had a conversion efficiency of 15%. Neutron irradiation with 48 meV neutrons was performed using one of the beamlines of the IRI nuclear research reactor in Delft, the Netherlands.

It was irradiated with β-irradiation from a ⁹⁰Sr/⁹⁰Y β source with a dose rate of 1 mGy/s in air. The thermo-luminescence was measured using a Risø-TL/PSL-DA-15A/B reader. Measurements were made following β-irradiation with doses of 30-3840 mGy and with a heating rate of 1 K/s.

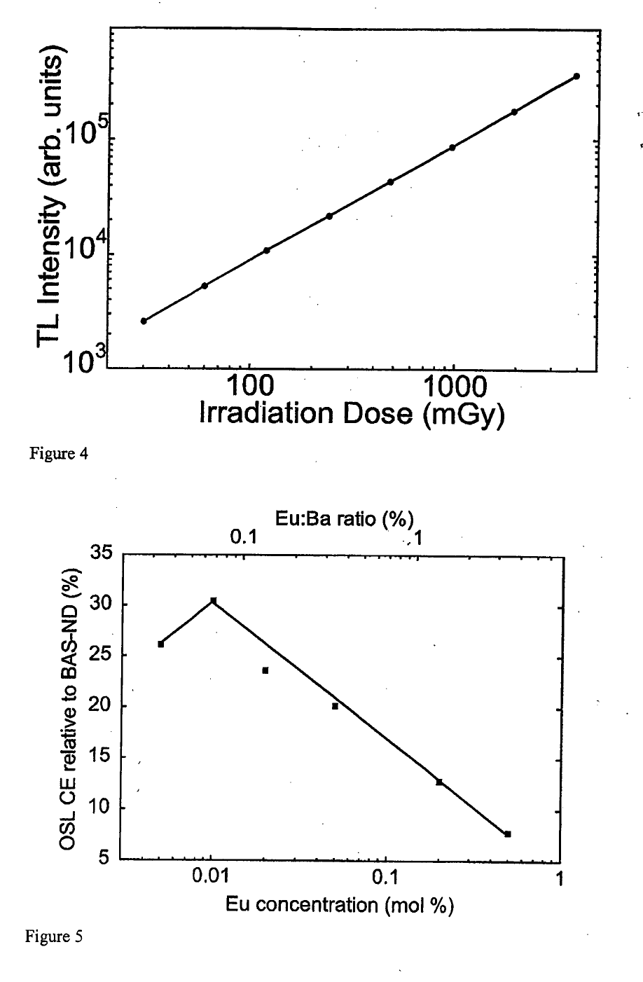

The total integrated TSL intensity is plotted in FIG. 4 against the irradiation dose. It can be seen that the total integrated TSL intensity has a simple power law dependence. Given the correspondence between TSL and OSL, it is expected that a similar dependence occurs for the OSL conversion efficiency. Samples displaying TSL have been found to show OSL after exposure to thermal neutrons. Thus, a power law dependence of the OSL conversion efficiency is expected after exposure to thermal neutrons.

The OSL conversion efficiency relative the Fuji NIP BAS-ND is plotted in FIG. 5 for a glass series where the EuCl₂ mole % was changed to x and the B₂O₃ and Li₂O mole % were increased to ensure that the total mole % was 100%. The processing was identical for all samples. The OSL was stimulated using x-rays from a W anode. It can be seen that the conversion efficiency is optimized for 0.01% Eu²⁺. Since the thermal neutron conversion efficiency relies on the detection of the ionizing products from the nuclear reaction between the neutrons and ¹⁰B and ⁶Li, it is expected that the thermal neutron conversion efficiency will be optimized for 0.01% Eu²⁺. Such a low amount of the phosphor ion will decrease the imaging plate residual radioactivity from neutron-induced europium radioisotopes.

### EXAMPLE 3

A borate glass made from 50.3 mole % of B₂O₃, 14.7 mole % of Li₂O, 20.8 mole % of LiF, 10.4 mole % of BaBr₂, 0.4 mole % of EuCl₂, 3.4 mol % SiO₂ and 0.005% CuO to act as a nucleating agent. It was quenched to 300° C. The as made glass contained some nanocrystallites of orthorhombic BaBr₂:Eu²⁺. The material was annealed at 480° C. for 10 minutes, which resulted in larger BaBr₂:Eu²⁺ crystallites with an increased volume fraction. The glass-ceramic was sensitive to x-rays and had an x-ray OSL conversion efficiency of 0.45% relative to the BAS-ND.

### EXAMPLE 4

A borate glass made from 50.3 mole % of B₂O₃, 14.7 mole % of Li₂O, 20.8 mole % of LiF, 10.4 mole % of BaBr₂, 0.4 mole % of EuCl₂, 3.4 mol % SiO₂. It was quenched to 300° C. The glass was annealed at 500° C. for 12 hours to produce a glass-ceramic containing BaFBr:Eu²⁺ crystallites as well as a minor phase of orthorhombic BaBr₂:Eu²⁺. The as-made glass was not sensitive to x-rays and hence it is not expected to be sensitive to thermal neutrons. The glass-ceramic was sensitive to x-rays and had an x-ray OSL conversion efficiency of 0.01% relative to the BAS-ND.

### EXAMPLE 5

A borate glass made from 53.1 mole % of B₂O₃, 24.1 mole % of Li₂O, 4.9 mole % of LiF, 14. mole % of BaCl₂, 0.02 mole % of CeF₃, 0.05 mole % of NaF and 3.8 mol % SiO₂. It was quenched to 300° C. The as-made glass contained some small crystallites of BaCl₂:Ce³⁺,Na⁺. The glass-ceramic was annealed at 540° C. for 10 minutes which resulted in a higher volume fraction of larger BaCl₂:Ce³⁺,Na⁺ crystallites. The annealed glass-ceramic was sensitive to x-rays and had an x-ray OSL conversion efficiency of 0.5% relative to the BAS-ND.

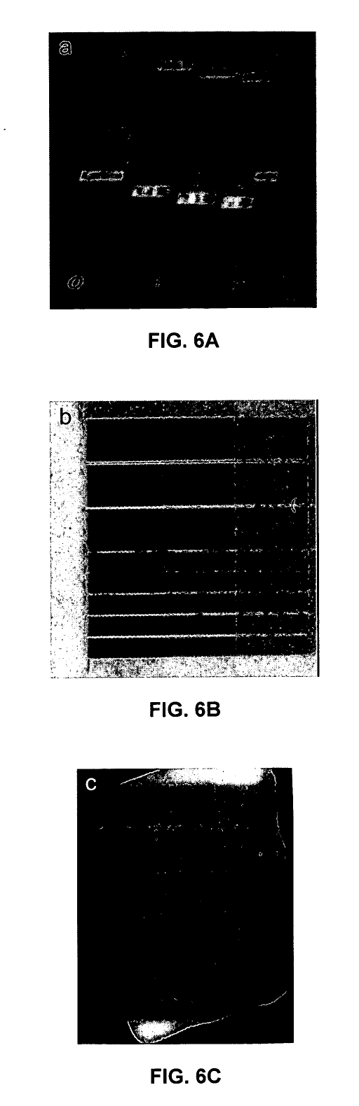

FIG. 6 shows (a) an optical photograph of a standard ASTM Neutron Image Sensitivity Indicator (scale in cm). This object is made of varying thicknesses of Perspex (neutron absorbing) and aluminium and lead (neutron transparent). FIG. 6(b) show the thermal neutron image of part of this material obtained using the Fuji BASND imaging plate. FIG. 6(c) shows the thermal neutron image of the same part of this material obtained using the glass-ceramic imaging plate discussed in Example 2. It can be seen that the quality of the image recorded on the glass-ceramic is comparable to that recorded on the BASND.

Advantages

The glass-ceramics described in the Examples have lower sensitivity to gamma rays than the BASND, leading to a sharper image for neutron radiographs recorded with most sources of neutron radiation which are inevitably accompanied by a diffuse gamma radiation background. The induced radioactivity has been calculated to be much lower than that of the BASND. The nanocrystalline nature of the material means that these materials have better spatial resolution than the BASND due to reduced readout light scattering. The non-flexible nature of the glass-ceramic removes a problem of distortion of the BASND surface from excessive bending. Thermal neutron detectors can be made by drawing the glass-ceramic into an optical fibre.

Applications

The glass-ceramic material can be used to record thermal neutron radiographs for non-destructive testing, airport-security and detection of explosives. Specific examples include, the detection of biological matter or explosives in parcels, containers etc., imaging of biological matter for medical and research applications, the industrial imaging for small biological objects or heath hazards in food processing plants, the imaging of hydrogen in hydrogen-based energy storage systems, the imaging of hydrocarbons and hydrogen containing lubricants in machinery and rocks, and the imaging and detection of defects in carbon composites (e.g. boats, aircraft wings etc.). These applications are in areas where the materials being imaged or the material to be detected have low atomic numbers and where the sensitivity to x-rays is low. The glass-ceramic material can also be used as a thermal neutron detector in scientific instrumentation applications, for example in neutron diffraction experiments.

Although the invention has been described with reference to specific examples, it will be appreciated by those skilled in the art that the invention may be embodied in many other forms, and that the compositions described can be arrived at by other combinations of starting materials.

1. A glass-ceramic material containing phosphor-doped crystallites, the glass-ceramic material capable of storing at least part of the energy of incident thermal neutrons, and releasing at least part of the energy by optical stimulation.

2. A glass-ceramic material as claimed in claim 1 wherein the glass-ceramic comprises the crystallites dispersed throughout a glass matrix having a composition:
(1-x-y)B₂O₃-xMₚO_{q}-y NᵣOₛ
wherein M, N are each selected from the group consisting of Li, Na, K, Rb, Cs, Ag, Mg, Ca, Sr, Zn, Pb, Al, La, Ba, Fe, Ti, Si, Mn and Gd), and p, q, r, s are 1, 2, or 3 as appropriate for each oxide.

3. A glass-ceramic material as claimed in claim 2 wherein the phosphor-doped crystallites are selected from one or more of the group consisting of:
MX:Z^{d+} (where M is one of Li, Na, K, Rb, Cs;
and X is one of F, Cl, Br, I), and
MX₂:Z^{d+} (where M is one of Mg, Ca, Cd, Zn, Sr, Ba;
and X is one of F, Cl, Br, I), and
MXY:Z^{d+} (where M is one of Mg, Ca, Cd, Zn, Sr, Ba;
and X is one of F, Cl, Br, I;
and Y is one of F, Cl, Br, I), and
MₐN_{b}X_{c}:Z^{d+} (where M is one of Li, Na, K, Rb, Cs;
and N is one of Mg, Ca, Sr, Ba, Cd, Zn;
and X is one of F, Cl, Br, I;)
with values abc corresponding to 113, 214 or 125.
wherein Z^{d+} is the dopant phosphor ion and is selected from the group consisting of the transition metal ions Cu⁺, Ag⁺, Mn²⁺, Mn⁴⁺, Cr³⁺ or rare earth metal ions: Eu²⁺, Sm²⁺, Sm³⁺, Ce³⁺, Pr³⁺, Gd³⁺, Tb³⁺, or Tl³⁺, Ga⁺, and Pb²⁺.

4. A glass-ceramic material as claimed in claim 3 wherein the crystallites are microcrystallites with particle size in the range 10-1000 nm.

5. A glass-ceramic material as claimed in claim 3 wherein the glass matrix further contains up to 6 mol % SiO₂.

6. A glass-ceramic material as claimed in claim 3 wherein the glass matrix is enriched with the ¹⁰B and/or ⁶Li isotopes.

7. A glass-ceramic material as claimed in claim 3 wherein the glass matrix or the crystallites contain Gd which is enriched with the ¹⁵⁷Gd isotope.

8. A glass-ceramic material as claimed in claim 3 wherein the glass-ceramic is also sensitive to one or more other forms of radiation selected from the group consisting of x-rays, gamma-rays, beta radiation, alpha radiation and other forms of ionizing radiation.

9. A method for producing a glass-ceramic material containing phosphor-doped crystallites, the glass-ceramic material capable of storing at least part of the energy of incident thermal neutrons, and releasing at least part of the energy by optical stimulation, the method comprising the steps:
[1] mixing the glass-ceramic precursors,
[2] thermal treatment at or above a melting temperature to melt the glass-ceramic precursors,
[3] quenching to below the melting temperature,
[4] production of a glass-ceramic containing or hosting phosphor-doped crystallites.

10. A method as claimed in claim 9 wherein one of the glass-ceramic precursors is a boron oxide or a source of boron oxide.

11. A method as claimed in claim 10 wherein one of the glass-ceramic precursors is B₂O₃ or orthoboric acid H₃BO₃.

12. A method as claimed in claim 11 wherein the B₂O₃ or H₃BO₃ is ¹⁰B-enriched.

13. A method as claimed in claim 9 wherein one or more or all the steps [1] to [4] is/are carried out under an atmosphere of argon with up to 5% by volume hydrogen.

14. A method as claimed in claim 9 wherein step [2] comprises the step of heating the glass-ceramic precursors to a temperature sufficient to melt the glass-ceramic precursors to a molten mixture.

15. A method as claimed in claim 14 wherein the temperature is between 800° C. and 1200° C.

16. A method as claimed in claim 9 wherein steps [3] to [4] involve:
quenching to a temperature between 25° C. to 300° C.,
slow cooling to room temperature,
annealing to between 450° C. and 550° C., and
cooling to room temperature
to produce the glass-ceramic.

17. A method as claimed in claim 9 wherein steps [3] to [4] involve:
quenching to a temperature between 450° C. to 550° C., and
slow cooling to room temperature
to produce the glass-ceramic.

18. A method as claimed in claim 9 wherein the glass-ceramic precursors comprise:
boron oxide (B₂O₃),
One or more metal oxides (where the metal is selected from the group consisting of Li, Na, K, Rb, Cs, Ag, Mg, Ca, Sr, Cd, Zn, Pb, Al, La, Ba, Fe, Ti, Si, Mn, and Gd),
a metal (A) halide (where A is selected from the group consisting of Li, Na, K, Rb, Mg, Ca, Sr, Ba, Cs, Cd, Zn), and
optionally a metal (B) halide (where B is selected from the group consisting of Li, Na, K, Rb, Mg, Ca, Sr, Ba, Cs, Cd, Zn), and
up to 2 mole percent dopant phosphor halides or oxides (where the dopant phosphor is selected from the group consisting of: Eu, Sm, Ce, Tb, Tl, In, Ga, Pr, Cu, Ag, Mn, Cr and Pb).

19. A method as claimed in claim 18 wherein the glass-ceramic precursors form a mixture in which the boron content is greater than 55 mol %.

20. A method as claimed in claim 19 wherein the mixture further includes one or both of SiO₂ and TiO₂

21. A method as claimed in claim 11 wherein prior to step [1] there is are the pre-steps of
heating the B₂O₃ to a temperature greater than 450° C., for a period of time, and
adding the remaining precursors to the B₂O₃ and heating to a temperature greater than 500° C., for a period of time.

22. A glass-ceramic material containing phosphor-doped crystallites, the glass-ceramic material capable of storing at least part of the energy of incident thermal neutrons, and releasing at least part of the energy by optical stimulation, prepared according to the method claimed in claim 1 or claim 21.

23. A method for recording and reproducing a thermal neutron image comprising the steps of:
i) providing a glass-ceramic material as claimed in claim 1,
ii) causing thermal neutron radiation to be incident upon the glass-ceramic material through an object to be imaged, so that the glass-ceramic material stores energy from the radiation;
iii) exposing the glass-ceramic to stimulating radiation to release the stored energy as emitted light;
iv) detecting the emitted light for imaging.

24. A method as claimed in claim 23 wherein the stimulating radiation is light of wavelength between 350-1000 nm.
